(19) United States
(12) Patent Application Publication
(10) Pub. No.: US 2012/0320012 A1
(43) Pub. Date: Dec. 20, 2012

(54) DISPLAY DEVICE AND ELECTRONIC APPARATUS

(75) Inventors: Masaya Tamaki, Kanagawa (JP); Norio Koma, Kanagawa (JP)

(73) Assignee: Sony Corporation, Tokyo (JP)

(21) Appl. No.: 13/488,566

(22) Filed: Jun. 5, 2012

(30) Foreign Application Priority Data
Jun. 20, 2011 (JP) 2011-136567

(51) Int. Cl. G09G 3/36; G09G 5/00

(52) U.S. Cl. 345/205; 345/88

(57) ABSTRACT

A display device includes: a liquid crystal layer driven based on an image signal; a reflection layer reflecting ambient light to the liquid crystal layer, in which the ambient light enters the reflection layer through the liquid crystal layer; a retardation layer provided on a side of the liquid crystal layer from which the ambient light enters; a polarizer provided on the side of the liquid crystal layer from which the ambient light enters; and a modulation layer varying a color tone of image light depending on illuminance of the ambient light. The image light is reflected from the reflection layer and is emitted to outside through the liquid crystal layer, the retardation layer, and the polarizer.

### BACKGROUND

This disclosure relates to a display device of a transmissive type, of a reflective type, or of a semi-transmissive type having both a reflection section and a transmission section, and to an electronic apparatus provided with the display device.

In recent years, there has been a growing demand for a display device directed to a mobile device such as a mobile phone and an electronic paper. A reflective display device, which can eliminate the use of backlight, attracts attention for the display device directed to the mobile device, from a viewpoint of achieving reduction in weight and size. As an example, reference is made to Japanese Patent Registration No. 2771392. The reflective display device, however, may not be used in the dark such as during the night and under an indoor environment. For this reason, a semi-transmissive display device or a transmissive display device is often mounted in the mobile device.

### SUMMARY

In general, yellowish white is not preferred in displaying an image. Hence, a color tone of image light is usually adjusted so that the white color has a bluish tone. In a reflective display device and a semi-transmissive display device, however, there is a trade-off between the color tone and lightness, and visibility of a panel may decrease under a dark environment with a reduced amount of ambient light.

Also, in a transmissive display device, visibility of a panel may decrease when illuminance of light derived from a backlight is insufficient, under a bright environment where the amount of ambient light is extreme such as in clear weather.

It is desirable to provide a display device capable of improving visibility of a panel, and an electronic apparatus provided with the display device.

A first display device according to an embodiment of the technology includes: a liquid crystal layer driven based on an image signal; a reflection layer reflecting ambient light to the liquid crystal layer, the ambient light entering the reflection layer through the liquid crystal layer; a retardation layer provided on a side of the liquid crystal layer from which the ambient light enters; a polarizer provided on the side of the liquid crystal layer from which the ambient light enters; and a modulation layer varying a color tone of image light depending on illuminance of the ambient light, the image light being reflected from the reflection layer and being emitted to outside through the liquid crystal layer, the retardation layer, and the polarizer.

A first electronic apparatus according to an embodiment of the technology includes a display device. The display device includes: a liquid crystal layer driven based on an image signal; a reflection layer reflecting ambient light to the liquid crystal layer, the ambient light entering the reflection layer through the liquid crystal layer; a retardation layer provided on a side of the liquid crystal layer from which the ambient light enters; a polarizer provided on the side of the liquid crystal layer from which the ambient light enters; and a modulation layer varying a color tone of image light depending on illuminance of the ambient light, the image light being reflected from the reflection layer and being emitted to outside through the liquid crystal layer, the retardation layer, and the polarizer.

A second display device according to an embodiment of the technology includes: a liquid crystal layer driven based on an image signal; a first polarizer; a second polarizer, the first polarizer and the second polarizer being disposed to face each other with the liquid crystal layer in between; an illumination device allowing light to be emitted from the first polarizer to the second polarizer; and a modulation layer varying a color tone of image light depending on illuminance of ambient light, the ambient light entering the modulation layer from a side of the modulation layer on which the second polarizer is provided, and the image light being emitted to outside through the first polarizer, the liquid crystal layer, and the second polarizer.

A second electronic apparatus according to an embodiment of the technology includes a display device. The display device includes: a liquid crystal layer driven based on an image signal; a first polarizer; a second polarizer, the first polarizer and the second polarizer being disposed to face each other with the liquid crystal layer in between; an illumination device allowing light to be emitted from the first polarizer to the second polarizer; and a modulation layer varying a color tone of image light depending on illuminance of ambient light, the ambient light entering the modulation layer from a side of the modulation layer on which the second polarizer is provided, and the image light being emitted to outside through the first polarizer, the liquid crystal layer, and the second polarizer.

In the display devices and the electronic apparatuses according to the respective embodiments of the technology described above, the color tone of the image light is varied depending on the illuminance of the ambient light. For example, the image light has a bluish color with a relative increase in the illuminance of the ambient light, and has a yellowish color with a relative decrease in the illuminance of the ambient light.

Such variation in the color tone of the image light may be achieved in one embodiment as follows. For example, under circumstances where a resin material of such as a film in the display device is not perfectly colorless nor is transparent and slightly has a yellowish color, the modulation layer itself may be so configured as to have a bluish color with the relative increase in the illuminance of the ambient light, and may be so configured as to have a light color or turn into colorless (become colorless and transparent) with the relative decrease in the illuminance of the ambient light.

The variation in the color tone of the modulation layer itself may be achieved in one embodiment by including a chromic material in the modulation layer, for example. Also, in one embodiment where the modulation layer includes a photochromic material and the polarizer allows ultraviolet rays to pass therethrough, the photochromic material reacts with the ultraviolet rays included in the ambient light, making it possible to vary the color tone of the modulation layer, for example. In one embodiment where the modulation layer includes an electrochromic material, and an electrode that applies a voltage to the modulation layer and a driving circuit that applies to the electrode the voltage corresponding to the illuminance of the ambient light are provided, the current is applied to the electrochromic material, making it possible to vary the color tone of the modulation layer.

According to the display devices and the electronic apparatuses of the respective embodiments of the technology described above, the color tone of the image light may be so made variable as to allow the image light to have a bluish color with a relative increase in the illuminance of the ambient light, and as to allow the image light to have a yellowish color with a relative decrease in the illuminance of the ambient light. This makes the image light brighter as compared with a case where image light is caused to have a bluish tone constantly under the circumstance in which illuminance of ambient light has decreased relatively. Hence, it is possible to improve visibility of a panel. It is to be noted that a user is interested in whether or not he or she can see and recognize an image rather than being interested in a color tone when the illuminance of the ambient light has decreased relatively, and thus the user hardly feels a sense of discomfort even when the image light is caused to have a yellowish tone as in one embodiment of the technology.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional view illustrating an exemplary configuration of a display device according to a first embodiment of the technology.

FIG. 2 illustrates an example of a relationship between illuminance of ambient light and a color tone of a modulation layer in the display device illustrated in FIG. 1.

FIG. 3 is a cross-sectional view illustrating an exemplary configuration of a display device according to a second embodiment of the technology.

FIG. 4 is a cross-sectional view illustrating an exemplary configuration of a display device according to a third embodiment of the technology.

FIG. 5 illustrates an example of a relationship between the illuminance of the ambient light and the color tone of the modulation layer in the display device illustrated in FIG. 4.

FIG. 6 is a cross-sectional view illustrating an exemplary configuration of a display device according to a fourth embodiment of the technology.

FIG. 7 is a perspective view illustrating an exemplary configuration of an electronic apparatus according to an application example.

FIG. 8 illustrates an example of a relationship between a color temperature and a reflectivity according to a comparative example.

FIG. 9 illustrates an example of a relationship among the color temperature, the reflectivity Y, and a Y ratio according to the comparative example.

### DETAILED DESCRIPTION

In the following, some embodiments of the technology will be described in detail with reference to the accompanying drawings. The description will be given in the following order.

1. First Embodiment (an embodiment directed to a display device where a modulation layer including a photochromic material is provided in a reflective display device).
2. Second Embodiment (an embodiment directed to a display device where a modulation layer including an electrochromic material is provided in a reflective display device).
3. Third Embodiment (an embodiment directed to a display device where a modulation layer including a photochromic material is provided in a transmissive display device).
4. Fourth Embodiment (an embodiment directed to a display device where a modulation layer including an electrochromic material is provided in a transmissive display device).
5. Application Examples (an embodiment directed to an electronic apparatus where the display device according to any one of the embodiments is applied to an electronic apparatus).

### 1. First Embodiment

### [Configuration]

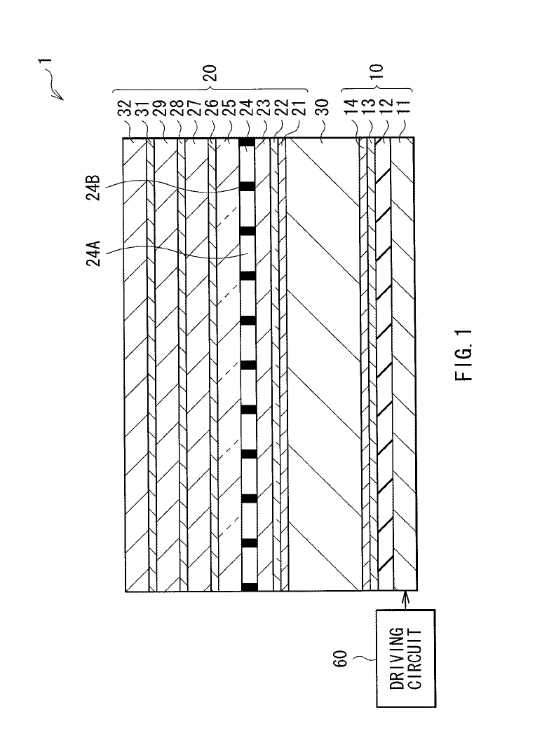

FIG. 1 illustrates an example of a cross-sectional configuration of a display device 1 according to a first embodiment of the technology. It is to be noted that FIG. 1 is a schematic illustration, and dimensions and shapes therein are not necessarily the same as the actual dimensions and shapes. The display device 1 corresponds to a specific but not limitative example of a “display device” according to one embodiment of the technology. The display device 1 may be a reflective display device or a semi-transmissive display device. Referring to FIG. 1, the display device 1 may include a lower substrate 10, an upper substrate 20, a liquid crystal layer 30 interposed between the lower substrate 10 and the upper substrate 20, and a driving circuit 60 that drives the lower substrate 10, for example. The liquid crystal layer 30 corresponds to a specific but not limitative example of a “liquid crystal layer” according to one embodiment of the technology. The driving circuit 60 corresponds to a specific but not limitative example of a “driving circuit” according to one embodiment of the technology.

In the display device 1, a top surface of the upper substrate 20 (such as a polarizer 32 described later, for example) serves as an image displaying plane, and a light source such as a backlight is not disposed on a back side of the lower substrate 10. In other words, the display device 1 is a reflective display device that displays an image by reflecting light that has entered the display device 1 from the picture displaying surface.

### [Liquid Crystal Layer 30]

The liquid crystal layer 30 may include nematic liquid crystals, for example. The liquid crystal layer 30 is driven based on an image signal, and has a modulation function of allowing the light incident on the liquid crystal layer 30 to pass therethrough and blocking the light, for each pixel by application of a voltage corresponding to the image signal. It is to be noted that a light-transmission level of the liquid crystals may be changed to adjust a gray-scale of each pixel.

### [Lower Substrate 10]

As illustrated in FIG. 1, the lower substrate 10 may include a drive substrate 11, an insulating layer 12, a reflection electrode layer 13, and an alignment film 14, for example. The drive substrate 11 may be formed with elements such as TFTs (Thin-Film Transistors). The insulating layer 12 may cover the elements such as the TFTs. The reflection electrode layer 13 may be electrically connected to the elements such as the TFTs. The alignment film 14 may be formed on a top surface of the reflection electrode layer 13. The reflection electrode layer 13 corresponds to a specific but not limitative example of a “reflection layer” according to one embodiment of the technology.

The drive substrate 11 has a pixel circuit that includes on a transparent substrate the elements such as the TFTs and capacitive elements. The transparent substrate can be a glass substrate, although it is not limited thereto. Alternatively, the transparent substrate can be a translucent resin substrate, a quartz substrate, a silicon substrate, or includes other suitable material other than the glass substrate, for example.

The reflection electrode layer 13 serves to drive, together with a later-described transparent electrode layer 22 located on the upper substrate 20 side, the liquid crystal layer 30. The reflection electrode layer 13 may include a plurality of pixel electrodes that are two-dimensionally arranged in a plane, for example. When a voltage is applied by the driving circuit 60 to the pixel electrodes and the transparent electrode layer 22, an electrical field corresponding to a potential difference between the pixel electrodes and the transparent electrode layer 22 is generated across the pixel electrodes and the transparent electrode layer 22. The pixel electrodes and the transparent electrode layer 22 thus drive the liquid crystal layer 30 in accordance with a magnitude of the electrical field. A portion in the display device 1 corresponding to a region where the pixel electrode and the transparent electrode layer 22 face each other defines the minimum unit that allows the liquid crystal layer 30 to be driven partially by the voltage applied across the pixel electrodes and the transparent electrode layer 22. This minimum unit corresponds to a pixel. The reflection electrode layer 13 serves as a reflection layer that reflects ambient light, which has passed through the liquid crystal layer 30 to enter the reflection electrode layer 13, to the liquid crystal layer 30. The reflection electrode layer 13 may include an electrically-conductive material that reflects visible light, which can be a metal material such as silver (Ag) and other suitable material, for example. The reflection electrode layer 13 has a surface that can be a mirror surface, for example.

The alignment film 14 serves to align liquid crystal molecules in the liquid crystal layer 30 in a predetermined direction, and may be in direct contact with the liquid crystal layer 30. The alignment film 14 can be a polymer material such as polyimide, and may be formed by performing a rubbing process on the coated polyimide or the like, for example.

### [Upper Substrate 20]

As illustrated in FIG. 1, the upper substrate 20 may include an alignment film 21, a transparent electrode layer 22, an overcoat layer (an OC layer) 23, a color filter (a CF layer) 24, and a transparent electrode 25, which may be provided in this order from the liquid crystal layer 30, for example.

The alignment film 21 serves to align the liquid crystal molecules in the liquid crystal layer 30 in a predetermined direction, and may be in direct contact with the liquid crystal layer 30. The alignment film 21 can be a polymer material such as polyimide, and may be formed by performing a rubbing process on the coated polyimide or the like, for example.

The transparent electrode layer 22 is disposed to face each of the pixel electrodes, and may be a sheet-like electrode formed throughout a plane as a whole, for example. The transparent electrode layer 22 is disposed to face each of the pixel electrodes to serve as a common electrode for each of the pixels. The transparent electrode 22 includes an electrically-conductive material transparent to the ambient light, which can be ITO (Indium Tin Oxide) or other suitable material, for example.

The overcoat layer 23 serves as an underlayer in forming the transparent electrode layer 22 during a manufacturing process. The color filter layer 24 has a color filter 24A in a region facing the pixel electrode, and a light-shielding film 24B in a region not facing the pixel electrode. The color filter 24A has a configuration in which color filters are arranged corresponding to the respective pixels. The color filters may separate the light having passed through the liquid crystal layer 30 into, for example but not limited to, three primary colors of red, green, and blue. The light-shielding film 24B may have a function of absorbing visible light, and may be provided between the pixels, for example. The transparent electrode 25 may be a substrate transparent to the ambient light, which can be a glass substrate or other suitable material, for example.

As illustrated in FIG. 1, the upper substrate 20 may include an adhesion layer 26, a ¼λ plate 27, an adhesion layer 28, a ½λ plate 29, an adhesion layer 31, and a polarizer 32, on a top surface of the transparent substrate 25 in this order from the liquid crystal layer 30, for example. Each of the ¼λ plate 27 and the ½λ plate 29 corresponds to a specific but not limitative example of a “retardation layer” according to one embodiment of the technology. Also, the polarizer 32 corresponds to a specific but not limitative example of a “polarizer” according to one embodiment of the technology.

The adhesion layer 26 may serve to attach the transparent substrate 25 and the ¼λ plate 27 together, and may include an adhesive material, for example. The adhesion layer 28 may serve to attach the ¼λ plate 27 and the ½λ plate 29 together, and may include an adhesive material, for example. The adhesion layer 31 may serve to attach the ½λ plate 29 and the polarizer 32 together, and may include an adhesive material, for example. Alternatively, a bonding layer that includes a bonding material may be provided instead of one or more of the adhesion layers 26, 28, and 31 described previously. At least one of the adhesion layer 26, the adhesion layer 28, and the adhesion layers 31 corresponds to a specific but not limitative example of a “modulation layer” according to one embodiment of the technology. Also, in one embodiment where the bonding layer that includes a bonding material is provided instead of one or more of the adhesion layers 26, 28, and 31, at least one of: the bonding layer provided instead of the adhesion layer 26; the bonding layer provided instead of the adhesion layer 28; and the bonding layer provided instead of the adhesion layer 31 corresponds to a specific but not limitative example of the “modulation layer” according to one embodiment of the technology. In other words, the modulation layer may be an adhesion layer which is a single layer in a plane as a whole, or may be a bonding layer which is a single layer in a plane as a whole. A layer corresponding to a specific but not limitative example of the “modulation layer” (hereinafter simply referred to as a modulation layer) in accordance with an embodiment of the technology will be described later in greater detail.

The ¼λ plate 27 can be a uniaxially-stretched resin film or other suitable material, for example. The retardation of the ¼λ plate 27 may be 0.14 μm, and is equivalent to approximately ¼ of the wavelength of green light in which a luminosity factor is the highest in the visible light, for example. The ¼λ plate 27 thus has a function of converting linearly-polarized light incident from the polarizer 32 into circularly-polarized light. The ½λ plate 29 can be a uniaxially-stretched film of a polycarbonate resin or other suitable material, for example. The retardation of ½λ plate 29 may be 0.27 μm, and is equivalent to approximately ½ of the wavelength of green light in which the luminosity factor is the highest in the visible light, for example. A combination of the ¼λ plate 27 and the ½λ plate 29, as a whole, has a function of converting the linearly-polarized light incident from the polarizer 32 into the circularly-polarized light, and functions as a (broadband) circular polarizer for a wide-ranging wavelength.

The polarizer 32 has a function of absorbing a predetermined linearly-polarized component, and allowing other polarized components to pass therethrough. In other words, the polarizer 32 thus has a function of converting external light incident from outside into linearly-polarized light. The polarizer 32 may be a polarizing plate that allows ultraviolet rays to pass therethrough, and may be preferably, but not necessarily, a polarizing plate without a function of cutting off the ultraviolet rays.

As necessary, one or more front-scattering plate may be optionally provided on or above the transparent substrate 25 in the upper substrate 20. Also, in one embodiment where the front-scattering plate is not provided on or above the transparent substrate 25 in the upper substrate 20, a surface of the reflection electrode layer 13 may have an asperity that scatters the light, for example.

### [Modulation Layer]

In the following, description is given on the modulation layer according to the first embodiment. The modulation layer serves to vary, depending on illuminance of the ambient light, a color tone of image light reflected from the reflection electrode layer 13 and to be emitted to the outside through the liquid crystal layer 30, the ¼λ plate 27, the ½λ plate 29, and the polarizer 32. The modulation layer may so vary the color tone of the image light as to allow the image light to have a bluish color with a relative increase in the illuminance of the ambient light, and may so vary the color tone of the image light as to allow the image light to have a yellowish color with a relative decrease in the illuminance of the ambient light.

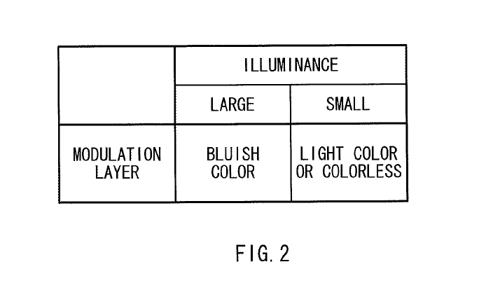

Such variation in the color tone of the image light may be achieved in one embodiment as follows. For example, under circumstances where a resin material of such as a film in the display device 1 is not perfectly colorless nor is transparent and slightly has a yellowish color, the modulation layer itself may be so configured as to have a bluish color with the relative increase in the illuminance of the ambient light, and may be so configured as to have a light color (a reduced color) or turn into colorless (become colorless and transparent) with the relative decrease in the illuminance of the ambient light (see FIG. 2).

The modulation layer may include a photochromic material, for example. The photochromic material is a type of chromic material, and whose color may change depending on an absorption amount per unit time of ultraviolet light, for example. When the absorption amount per unit time of the ultraviolet light changes, the color of the photochromic material varies following that change in the absorption amount accordingly. For example, the photochromic material may have a bluish color with the relative increase in the absorption amount per unit time of the ultraviolet light, and may have a light color or turn into colorless (becomes colorless and transparent) with the relative decrease in the absorption amount per unit time of the ultraviolet light, when a resin material of a film or the like in the display device 1 is not perfectly colorless nor is transparent and slightly has a yellowish color.

### [Function and Effect]

In the following, description is given on function and effects of the display device 1 according to the first embodiment.

In the present embodiment, the ambient light incident in a specific direction is converted by the polarizer 32 into the linearly-polarized light, following which the linearly-polarized light is further converted by the ½λ plate 29 and the ¼λ plate 27 into the circularly-polarized light to enter the liquid crystal layer 30 thereafter. The light which has entered the liquid crystal layer 30 is modulated in the liquid crystal layer 30 in accordance with the image signal, following which the modulated light is reflected by the reflection electrode layer 13. The light reflected from the reflection electrode layer 13 is converted by the ¼λ plate 27 and the ½λ plate 29 into the linearly-polarized light, which then passes through the polarizer 32 to be emitted to the outside as the image light.

In general, yellowish white is not preferred in displaying an image. Hence, a color tone of image light is usually adjusted so that the white color has a bluish tone. In a reflective display device and a semi-transmissive display device, however, there is a trade-off between the color tone and lightness, and visibility of a panel may decrease under a dark environment with a reduced amount of ambient light.

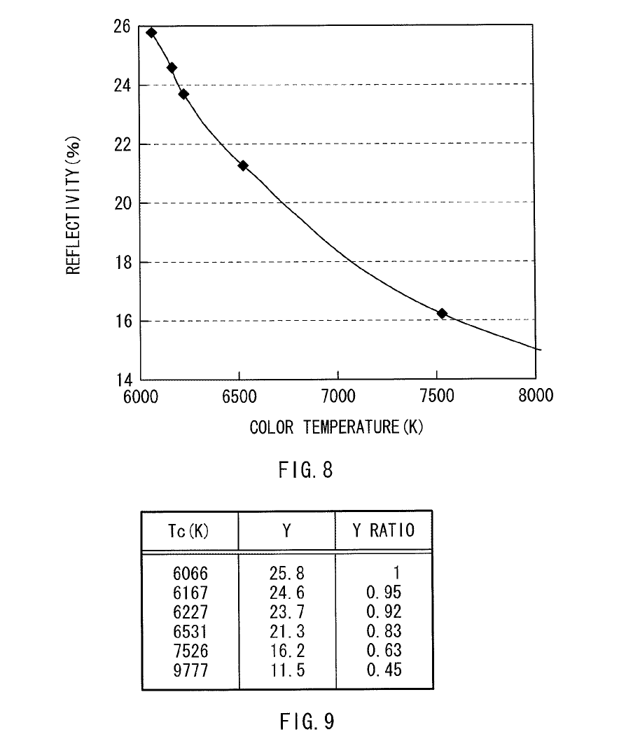

FIG. 8 illustrates an example of a relationship between a color temperature and a reflectivity according to a comparative example. FIG. 9 illustrates an example of a relationship among the color temperature, the reflectivity Y, and a Y ratio. FIGS. 8 and 9 each illustrate a change in the reflectivity, with the conditions under which a color temperature 6066K is a color tone of a monochrome panel and under which adjustment of such as a color filter and a film is made thereto to increase the color temperature. It can be seen from a result in FIGS. 8 and 9 that a reflectivity of a color temperature 6531K has a value which is about twenty percent lower than the reflectivity of the color temperature 6066K when comparing the color temperature 6066K with the color temperature 6531K.

In contrast, according to the present embodiment, the color tone of the image light varies depending on the illuminance of the ambient light. For example, when the ambient light enters the modulation layer and the ultraviolet light included in the ambient light is absorbed by the photochromic material present in the modulation layer, the modulation layer changes to have the color tone corresponding to the illuminance of the ambient light. This causes the light (the image light) that has passed through the modulation layer to have a bluish color when the illuminance of the ambient light is large relatively, and to causes the light to have a yellowish color when the illuminance of the ambient light is small relatively. As a result, the image light is made brighter as compared with a case where image light is caused to have a bluish tone constantly under the circumstance in which illuminance of ambient light has decreased relatively, making it possible to improve visibility of a panel. It is to be noted that a user is, in general, interested in whether or not he or she can see and recognize an image rather than being interested in a color tone when the illuminance of the ambient light has decreased relatively, and thus the user hardly feels a sense of discomfort even when the image light is caused to have a yellowish tone as in the present embodiment. Hence, according to the first embodiment, it is possible to improve the visibility of the panel without bringing a sense of discomfort to the user.

### [Modification]

In one embodiment, a layer different from the layer described above may serve as the modulation layer. For example, the overcoat layer 23 or the polarizer 32 may be the modulation layer. Also, a layer having a plurality of layers in a plane as a whole may serve as the modulation layer. For example, the color filter layer 24 (in particular, the color filter 24A) may be the modulation layer.

### 2. Second Embodiment

### [Configuration]

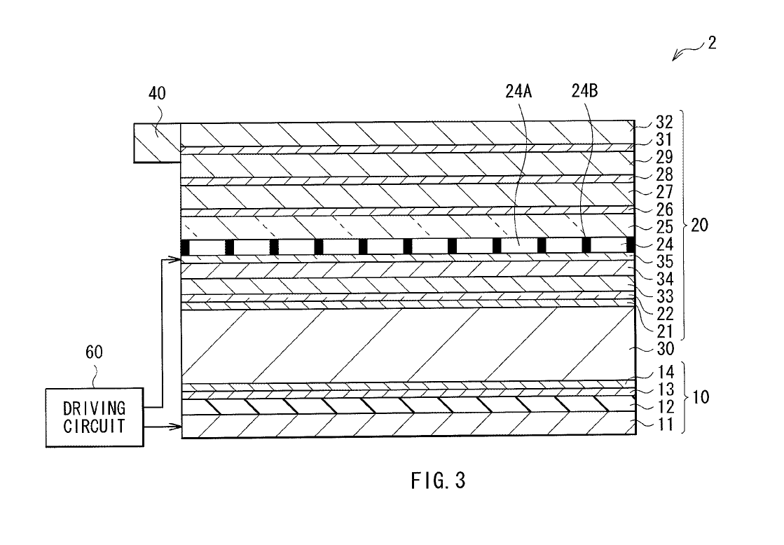

FIG. 3 illustrates an example of a cross-sectional configuration of a display device 2 according to a second embodiment of the technology. It is to be noted that FIG. 3 is a schematic illustration, and dimensions and shapes therein are not necessarily the same as the actual dimensions and shapes. The display device 2 corresponds to a specific but not limitative example of a “display device” according to one embodiment of the technology. The display device 2 may be a reflective display device or a semi-transmissive display device. Referring to FIG. 3, the display device 2 may include the lower substrate 10, the upper substrate 20, and the liquid crystal layer 30 interposed between the lower substrate 10 and the upper substrate 20, for example. The display device 2 further includes a light detector 40 and the driving circuit 60. The light detector 40 detects the ambient light and outputs a signal indicative of the illuminance of the ambient light. The driving circuit 60 drives the reflection electrode layer 13 and drives a later-described transparent electrode layer 35.

The display device 2 differs in configuration from the display device 1 described above, in that an electron transport layer 33, a modulation layer 34, and the transparent electrode layer 35 are provided instead of the overcoat layer 23, and the light detector 40 is further provided. The display device 2 also differs in configuration from the above-described display device 1, in that the driving circuit 60 drives not only the lower substrate 10 but also the transparent electrode layer 35. In the following, description is given mainly on differences between the display device 2 and the above-described display device 1, and elements of the display device 2 common to those of the display device 1 will not be described in detail. Also, the same or equivalent elements as those of the display device 1 described above are denoted with the same reference numerals.

The electron transport layer 33 has a function of increasing an efficiency of transporting electrons to the modulation layer 34. The transparent electrode layer 35 is an electrode capable of applying a voltage to the modulation layer 34. The transparent electrode layer 35 serves to drive the modulation layer 34 in cooperation with the transparent electrode layer 22, and may be a sheet-like electrode formed throughout a plane as a whole, for example. When a voltage is applied by the driving circuit 60 to the transparent electrode layer 35 and the transparent electrode layer 22, a current flows to the modulation layer 34 provided between the transparent electrode layer 35 and the transparent electrode layer 22. The transparent electrode layer 35 and the transparent electrode layer 22 thus modulate a color tone of the modulation layer 34 depending on a magnitude and a direction of the current.

The light detector 40 detects ambient light, and may include a photodiode, for example. The light detector 40 may be disposed in the vicinity of an image displaying plane (for example, in a frame region), for example. When the light detector 40 has detected the ambient light, the light detector 40 outputs a signal corresponding to illuminance of that ambient light. The driving circuit 60 applies a voltage corresponding to the illuminance of the ambient light to the transparent electrode layer 35 (or to the transparent electrode layers 22 and 35), based on the signal outputted from the light detector 40. For example, based on the signal outputted from the light detector 40, the driving circuit 60 may apply to the transparent electrode layer 35 (or to the transparent electrode layers 22 and 35) the voltage that has a correlation (for example, a proportional relationship) with a change in the illuminance of the ambient light.

When the transparent electrode layer 22 has a constant voltage (such as zero volts) under the circumstances in which the change in the signal outputted from the light detector 40 indicates an increase in the illuminance of the ambient light, the driving circuit 60 may apply to the transparent electrode layer 35 a voltage that changes in a positive direction, for example. As used herein, the wording “a voltage that changes in a positive direction” refers to such change in the voltage, for example, from 0.3 volts to 0.4 volts with the addition of 0.1 volts when the voltage is originally at 0.3 volts, from minus one volt to plus one volt with the addition of two volts when the voltage is originally at the minus one volt, and so forth. Also, when the transparent electrode layer 22 has a constant voltage (such as zero volts) under the circumstances in which the change in the signal outputted from the light detector 40 indicates a decrease in the illuminance of the ambient light, the driving circuit 60 may apply to the transparent electrode layer 35 a voltage that changes in a negative direction, for example. As used herein, the wording “a voltage that changes in a negative direction” refers to such change in the voltage, for example, from 0.3 volts to 0.2 volts with the deduction of 0.1 volts when the voltage is originally at 0.3 volts, from plus one volt to minus one volt with the deduction of two volts when the voltage is originally at the plus one volt, and so forth.

Alternatively, the driving circuit 60 may apply to the transparent electrode layer 35 the voltage that changes in the negative direction, when the transparent electrode layer 22 has a constant voltage (such as zero volts) under the circumstances in which the change in the signal outputted from the light detector 40 indicates the increase in the illuminance of the ambient light, for example. Also, the driving circuit 60 may apply to the transparent electrode layer 35 the voltage that changes in the positive direction, when the transparent electrode layer 22 has a constant voltage (such as zero volts) under the circumstances in which the change in the signal outputted from the light detector 40 indicates the decrease in the illuminance of the ambient light, for example.

Further, based on the signal outputted from the light detector 40, the driving circuit 60 may apply the voltage, that has the correlation (for example, a proportionate relationship) with the change in the illuminance of the ambient light, to the transparent electrode layer 22 as well. In this embodiment, the driving circuit 60 may so apply to the transparent electrode layers 22 and 35 a voltage as to allow a potential difference (V35−V22) between the transparent electrode layer 35 and the transparent electrode layer 22 to change in a positive direction, under the circumstances in which the change in the signal outputted from the light detector 40 indicates the increase in the illuminance of the ambient light, for example (where V35 is a voltage of the transparent electrode layer 35 and V22 is a voltage of the transparent electrode layer 22). As used herein, the wording “allow a potential difference between the transparent electrode layer 35 and the transparent electrode layer 22 to change in a positive direction” refers to such change in the potential difference, for example, from 0.3 volts to 0.4 volts with the addition of 0.1 volts when the potential difference is originally at plus 0.3 volts, from minus one volt to plus one volt with the addition of two volts when the potential difference is originally at the minus one volt, and so forth. Also, the driving circuit 60 may so apply to the transparent electrode layers 22 and 35 a voltage as to allow the potential difference (V35−V22) between the transparent electrode layer 35 and the transparent electrode layer 22 to change in a negative direction, under the circumstances in which the change in the signal outputted from the light detector 40 indicates the decrease in the illuminance of the ambient light, for example. As used herein, the wording “allow a potential difference between the transparent electrode layer 35 and the transparent electrode layer 22 to change in a negative direction” refers to such change in the potential difference, for example, from 0.3 volts to 0.2 volts with the deduction of 0.1 volts when the potential difference is originally at 0.3 volts, from plus one volt to minus one volt with the deduction of two volts when the potential difference is originally at the plus one volt, and so forth.

Alternatively, the driving circuit 60 may so apply to the transparent electrode layers 22 and 35 the voltage as to allow the potential difference between the transparent electrode layer 35 and the transparent electrode layer 22 to change in the negative direction, under the circumstances in which the change in the signal outputted from the light detector 40 indicates the increase in the illuminance of the ambient light, for example. Also, the driving circuit 60 may so apply to the transparent electrode layers 22 and 35 the voltage as to allow the potential difference between the transparent electrode layer 35 and the transparent electrode layer 22 to change in the positive direction, under the circumstances in which the change in the signal outputted from the light detector 40 indicates the decrease in the illuminance of the ambient light, for example. The driving circuit 60 thus changes the magnitude and the direction of the current flowing in the modulation layer 34 to modulate the color tone of the modulation layer 34.

The modulation layer 34 may be a single layer in a plane as a whole. The modulation layer 34 may so vary the color tone of the image light as to allow the image light to have a more bluish color, under conditions in which the current flows in the modulation layer 34 from the transparent electrode layer 22 to the transparent electrode layer 35 and in which a value of the current increases gradually, for example. The modulation layer 34 may also so vary the color tone of the image light as to allow the image light to have a more bluish color, under conditions in which the current flows in the modulation layer 34 from the transparent electrode layer 35 to the transparent electrode layer 22 and in which the value of the current decreases gradually, for example. Meanwhile, the modulation layer 34 may so vary the color tone of the image light as to allow the image light to have a more yellowish color, under conditions in which the current flows in the modulation layer 34 from the transparent electrode layer 22 to the transparent electrode layer 35 and in which the value of the current decreases gradually, for example. The modulation layer 34 may also so vary the color tone of the image light as to allow the image light to have a more yellowish color, under conditions in which the current flows in the modulation layer 34 from the transparent electrode layer 35 to the transparent electrode layer 22 and in which the value of the current increases gradually, for example.

The magnitude and the direction of the current applied to the modulation layer 34 has a correlation with (for example, in proportional to or in inversely proportional to) the illuminance of the ambient light. Hence, the modulation layer 34 varies the color tone of the image light depending on the illuminance of the ambient light. For example, the modulation layer 34 may so vary the color tone of the image light as to allow the image light to have a more bluish color with the relative increase in the illuminance of the ambient light, and may so vary the color tone of the image light as to allow the image light to have a more yellowish color with the relative decrease in the illuminance of the ambient light.

Such variation in the color tone of the image light may be achieved in one embodiment as follows. For example, under circumstances where a resin material of such as a film in the display device 2 is not perfectly colorless nor is transparent and slightly has a yellowish color, the modulation layer itself may be so configured as to have a more bluish color with the relative increase in the illuminance of the ambient light, and may be so configured as to have a lighter color or turn into colorless (become colorless and transparent) with the relative decrease in the illuminance of the ambient light (see FIG. 2).

The modulation layer 34 may include an electrochromic material, for example. The electrochromic material is a type of chromic material, and whose color may change depending on a magnitude and a direction of an applied current, for example. When the magnitude or the direction of the applied current changes over time, the color of the electrochromic material varies following that change over time in the magnitude or the direction accordingly.

For example, in a case where a resin material of a film or the like in the display device 2 is not perfectly colorless nor is transparent and slightly has a yellowish color, the electrochromic material may have a more bluish color with, for example, the relative increase in the magnitude of the current flowing from the transparent electrode layer 22 to the transparent electrode layer 35, the relative decrease in the magnitude of the current flowing from the transparent electrode layer 35 to the transparent electrode layer 22, and so forth. Further, in the case described above, the electrochromic material may have a lighter color or turn into colorless (becomes colorless and transparent) with, for example, the relative decrease in the magnitude of the current flowing from the transparent electrode layer 22 to the transparent electrode layer 35, the relative increase in the magnitude of the current flowing from the transparent electrode layer 35 to the transparent electrode layer 22, and so forth.

### [Function and Effect]

In the following, description is given on function and effects of the display device 2 according to the second embodiment.

In the present embodiment, the ambient light incident in a specific direction is converted by the polarizer 32 into the linearly-polarized light, following which the linearly-polarized light is further converted by the ½λ plate 29 and the ¼λ plate 27 into the circularly-polarized light to enter the liquid crystal layer 30 thereafter. The light which has entered the liquid crystal layer 30 is modulated in the liquid crystal layer 30 in accordance with the image signal, following which the modulated light is reflected by the reflection electrode layer 13. The light reflected from the reflection electrode layer 13 is converted by the ¼λ plate 27 and the ½λ plate 29 into the linearly-polarized light, which then passes through the polarizer 32 to be emitted to the outside as the image light.

According to the present embodiment, the color tone of the image light varies depending on the illuminance of the ambient light. More specifically, when the ambient light is detected by the light detector 40 and the signal corresponding to the illuminance of that ambient light is thus outputted from the light detector 40, the voltage having a correlation with (for example, in proportional to or in inversely proportional to) the illuminance of the ambient light is applied by the driving circuit 60 to the transparent electrode layer 35 (or to the transparent electrode layer 22 and 35). This causes the modulation layer 34 to have the color tone corresponding to the illuminance of the ambient light.

For example, under circumstances where a resin material of such as a film in the display device 2 is not perfectly colorless nor is transparent and slightly has a yellowish color, the modulation layer 34 may have a more bluish color with the relative increase in the illuminance of the ambient light, and may have a lighter color or turn into colorless (become colorless and transparent) with the relative decrease in the illuminance of the ambient light.

As a result, the image light is made brighter in the occurrence of the relative decrease in the illuminance of the ambient light as compared with a case where a film having a bluish tone is used to cause image light to have a bluish tone constantly, making it possible to improve visibility of a panel. It is to be noted that a user is, in general, interested in whether or not he or she can see and recognize an image rather than being interested in a color tone when the illuminance of the ambient light has decreased relatively, and thus the user hardly feels a sense of discomfort even when the image light is caused to have a yellowish tone as in the present embodiment. Hence, according to the second embodiment, it is possible to improve the visibility of the panel without bringing a sense of discomfort to the user.

### [Modification]

In one embodiment, the modulation layer 34 may be disposed at a location different from that according to the second embodiment described above. In this embodiment, it is preferable that a configuration is employed by which a voltage is applicable to the modulation layer 34.

### 3. Third Embodiment

### [Configuration]

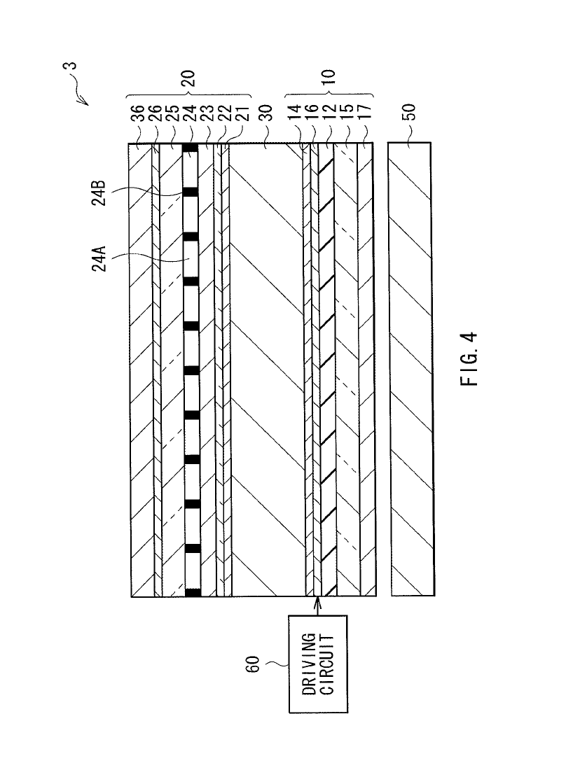

FIG. 4 illustrates an example of a cross-sectional configuration of a display device 3 according to a third embodiment of the technology. It is to be noted that FIG. 4 is a schematic illustration, and dimensions and shapes therein are not necessarily the same as the actual dimensions and shapes. The display device 3 corresponds to a specific but not limitative example of a “display device” according to one embodiment of the technology. The display device 3 can be a transmissive display device, and may have an illumination device 50 on the back of the lower substrate 10 as illustrated in FIG. 4, for example. The illumination device 50 may have a light-guide plate, a light source disposed at a side face of the light-guide plate, and a reflector disposed on the back of the light-guide plate, for example. It is to be noted that the illumination device 50 is not limited to a side-edge type illumination device as described above, and can be a direct illumination device or an illumination device employing other scheme.

As with the first embodiment described above, the display device 3 may include the lower substrate 10, the upper substrate 20, the liquid crystal layer 30 interposed between the lower substrate 10 and the upper substrate 20, and the driving circuit 60 that drives a later-described transparent electrode layer 16. In the present embodiment, the lower substrate 10 differs in configuration from the lower substrate 10 according to the first embodiment, in that: a transparent substrate 15 is provided instead of the drive substrate 11; a transparent electrode layer 16 is provided instead of the reflection electrode layer 13; and a polarizer 17 is provided on a rear face of the transparent substrate 15. Also, in the present embodiment, the upper substrate 20 differs in configuration from the upper substrate 20 according to the first embodiment, in that a polarizer 36 is provided instead of the ¼λ plate 27, the adhesion layer 28, the ½λ plate 29, the adhesion layer 31, and the polarizer 32.

The transparent substrate 15 can be a glass substrate or other suitable substrate. The reflection electrode layer 16 serves to drive, together with the transparent electrode layer 22, the liquid crystal layer 30. The reflection electrode layer 16 may include the plurality of pixel electrodes that are two-dimensionally arranged in a plane, for example. When a voltage is applied by the driving circuit 60 to the pixel electrodes and the transparent electrode layer 22, an electrical field corresponding to a potential difference between the pixel electrodes and the transparent electrode layer 22 is generated across the pixel electrodes and the transparent electrode layer 22. The pixel electrodes and the transparent electrode layer 22 thus drive the liquid crystal layer 30 in accordance with a magnitude of the electrical field. A portion in the display device 3 corresponding to a region where the pixel electrode and the transparent electrode layer 22 face each other defines the minimum unit that allows the liquid crystal layer 30 to be driven partially by the voltage applied across the pixel electrodes and the transparent electrode layer 22. This minimum unit corresponds to a pixel. As with the transparent electrode layer 22, the transparent substrate 15 may include an electrically-conductive material transparent to the ambient light, which can be ITO or other suitable material, for example.

Each of the polarizers 17 and 36 allows only the light with a certain constant oscillation direction (polarization) to pass therethrough, as with the polarizer 32. The polarizers 17 and 36 are so disposed as to allow respective polarization axes to be different in angle from each other at 90 degrees, allowing light emitted from the illumination device 50 to pass therethrough via the liquid crystal layer 30 or to be blocked thereby. The polarizers 17 and 36 each may be a polarizing plate that allows ultraviolet rays to pass therethrough, and may be preferably, but not necessarily, a polarizing plate without a function of cutting off the ultraviolet rays.

### [Modulation Layer]

In the following, description is given on the modulation layer according to the third embodiment. In the present embodiment, the adhesion layer 26 or a bonding layer provided instead of the adhesion layer 26 serves as the modulation layer. In other words, the modulation layer of the present embodiment may be an adhesion layer which is a single layer in a plane as a whole, or may be a bonding layer which is a single layer in a plane as a whole, as with the first embodiment described above. The modulation layer serves to vary, depending on the illuminance of the ambient light, a color tone of image light emitted from the illumination device 50 and to be emitted to the outside through the polarizer 17, the liquid crystal layer 30, and the polarizer 36. The modulation layer may so vary the color tone of the image light as to allow the image light to have a yellowish color with the relative increase in the illuminance of the ambient light, and may so vary the color tone of the image light as to allow the image light to have a bluish color with the relative decrease in the illuminance of the ambient light.

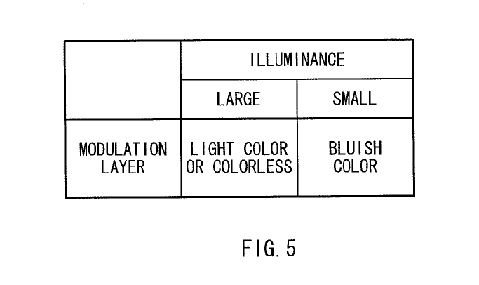

Such variation in the color tone of the image light may be achieved in one embodiment as follows. For example, under circumstances where a resin material of such as a film in the display device 3 is not perfectly colorless nor is transparent and slightly has a yellowish color, the modulation layer itself may be so configured as to have a light color or turn into colorless (become colorless and transparent) with the relative increase in the illuminance of the ambient light, and may be so configured as to have a bluish tone with the relative decrease in the illuminance of the ambient light (see FIG. 5).

It is preferable that the modulation layer itself be so configured as to have a light color or turn into colorless (become colorless and transparent) with the relative increase in the illuminance of the ambient light, and be so configured as to have a bluish color with the relative decrease in the illuminance of the ambient light, also under circumstances where a resin material of such as a film in the display device 3 is not perfectly colorless nor is transparent and slightly has a bluish color. In this case, however, the bluish tone in the image light decreases with the relative increase in the illuminance of the ambient light, and the bluish tone in the image light increases with the relative decrease in the illuminance of the ambient light. Hence, in such case, the modulation layer 34 may so vary the color tone of the image light as to allow the image light to have a less bluish color with the relative increase in the illuminance of the ambient light, and to allow the image light to have a more bluish color with the relative decrease in the illuminance of the ambient light.

The modulation layer may include a photochromic material which is a type of chromic material, for example. For example, the photochromic material may have a light color or turn into colorless (becomes colorless and transparent) with the relative increase in the absorption amount per unit time of the ultraviolet light, and may have a bluish color with the relative decrease in the absorption amount per unit time of the ultraviolet light, when a resin material of a film or the like in the display device 3 is not perfectly colorless nor is transparent and slightly has a yellowish color. Also, when a resin material of a film or the like in the display device 3 is not perfectly colorless nor is transparent and slightly has a bluish color, the photochromic material may preferably have a light color or turn into colorless (becomes colorless and transparent) with the relative increase in the absorption amount per unit time of the ultraviolet light, and may preferably have a bluish color with the relative decrease in the absorption amount per unit time of the ultraviolet light

### [Function and Effect]

In the following, description is given on function and effects of the display device 3 according to the third embodiment.

In the present embodiment, illumination light, having emitted from the illumination device 50 and having entered the polarizer 17, is converted by the polarizer 32 into the linearly-polarized light, following which the linearly-polarized light enters the liquid crystal layer 30. The light which has entered the liquid crystal layer 30 is modulated in the liquid crystal layer 30 in accordance with the image signal, following which the modulated light passes through the polarizer 36 to be emitted to the outside as the image light.

According to the present embodiment, the color tone of the image light varies depending on the illuminance of the ambient light. For example, when the ambient light enters the modulation layer and the ultraviolet light included in the ambient light is absorbed by the photochromic material present in the modulation layer, the modulation layer changes to have the color tone corresponding to the illuminance of the ambient light. More specifically, the modulation layer varies to have a color tone by which a transmittance of light increases relatively under the circumstances in which the illuminance of the ambient light is large relatively. This makes it possible to increase luminance of the image light under the circumstances in which the illuminance of the ambient light is extremely large, as compared with a case where the illuminance of the ambient light is small. In other words, this makes it possible to increase the luminance of the image light of the image light more than that of the case where the illuminance of the ambient light is small under the circumstances in which the illuminance of the ambient light is extremely large, without varying an intensity of the light emitted from the illumination device 50. As a result, it is possible to improve visibility of a panel. It is to be noted that a user is, in general, interested in whether or not he or she can see and recognize an image rather than being interested in a color tone when the illuminance of the ambient light is extremely large, and thus the user hardly feels a sense of discomfort even when the image light is caused to have a yellowish tone as in the present embodiment. Hence, according to the third embodiment, it is possible to improve the visibility of the panel without bringing a sense of discomfort to the user.

### [Modification]

In one embodiment, a layer different from the layer described above may serve as the modulation layer. For example, the overcoat layer 23 or the polarizer 36 may be the modulation layer. Also, a layer having a plurality of layers in a plane as a whole may serve as the modulation layer. For example, the color filter layer 24 (in particular, the color filter 24A) may be the modulation layer.

### 4. Fourth Embodiment

### [Configuration]

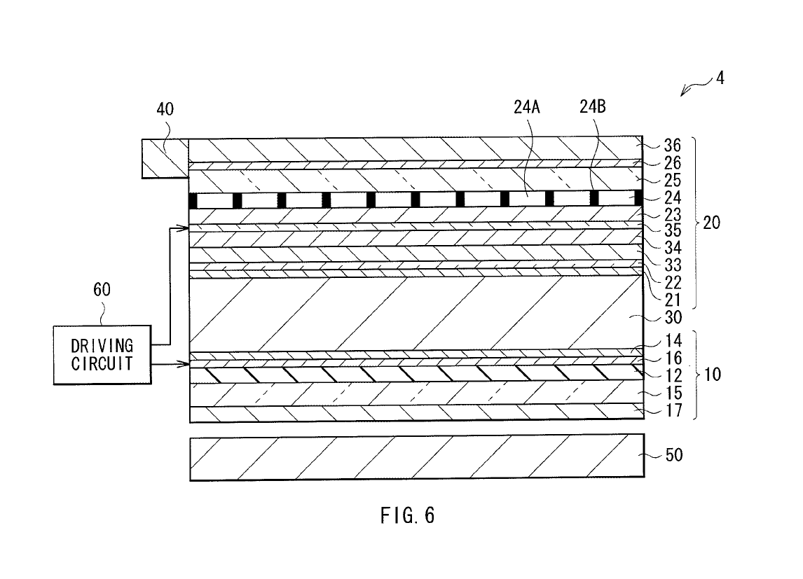

FIG. 6 illustrates an example of a cross-sectional configuration of a display device 4 according to a fourth embodiment of the technology. It is to be noted that FIG. 6 is a schematic illustration, and dimensions and shapes therein are not necessarily the same as the actual dimensions and shapes. The display device 4 corresponds to a specific but not limitative example of a “display device” according to one embodiment of the technology. The display device 4 can be a transmissive display device, and may have the illumination device 50 on the back of the lower substrate 10 as illustrated in FIG. 6, for example.

The display device 4 may include the lower substrate 10, the upper substrate 20, the liquid crystal layer 30, the light detector 40, and the driving circuit 60 that drives the transparent electrode layer 16 and 35. In the present embodiment, the lower substrate 10 has the same configuration as that of the lower substrate 10 according to the third embodiment described above. Also, in the present embodiment, the upper substrate 20 differs in configuration from the upper substrate 20 according to the above-described third embodiment, in that the electron transport layer 33, the modulation layer 34, and the transparent electrode layer 35 are provided in this order from the liquid crystal layer 30 between the transparent electrode layer 22 and the overcoat layer 23. The driving circuit 60 in the present embodiment drives the transparent electrode layer 35 (or to the transparent electrode layers 22 and 35) in a way similar to that of the driving circuit 60 according to the second embodiment described above. More specifically, the driving circuit 60 applies a voltage corresponding to the illuminance of the ambient light to the transparent electrode layer 35 (or to the transparent electrode layers 22 and 35), based on the signal outputted from the light detector 40. For example, based on the signal outputted from the light detector 40, the driving circuit 60 may apply to the transparent electrode layer 35 (or to the transparent electrode layers 22 and 35) the voltage that has a correlation (for example, a proportional relationship) with a change in the illuminance of the ambient light.

### [Modulation Layer]

In the following, description is given on the modulation layer according to the fourth embodiment. In the present embodiment, the modulation layer 34 may so vary the color tone of the image light as to allow the image light to have a more bluish color, under conditions in which the current flows in the modulation layer 34 from the transparent electrode layer 22 to the transparent electrode layer 35 and in which a value of the current increases gradually, for example. The modulation layer 34 may also so vary the color tone of the image light as to allow the image light to have a more bluish color, under conditions in which the current flows in the modulation layer 34 from the transparent electrode layer 35 to the transparent electrode layer 22 and in which the value of the current decreases gradually, for example. Meanwhile, the modulation layer 34 may so vary the color tone of the image light as to allow the image light to have a more yellowish color, under conditions in which the current flows in the modulation layer 34 from the transparent electrode layer 22 to the transparent electrode layer 35 and in which the value of the current decreases gradually, for example. The modulation layer 34 may also so vary the color tone of the image light as to allow the image light to have a more yellowish color, under conditions in which the current flows in the modulation layer 34 from the transparent electrode layer 35 to the transparent electrode layer 22 and in which the value of the current increases gradually, for example.

The magnitude and the direction of the current applied to the modulation layer 34 has a correlation with (for example, in proportional to or in inversely proportional to) the illuminance of the ambient light. Hence, the modulation layer 34 varies the color tone of the image light depending on the illuminance of the ambient light. For example, the modulation layer may so vary the color tone of the image light as to allow the image light to have a more yellowish color with the relative increase in the illuminance of the ambient light, and may so vary the color tone of the image light as to allow the image light to have a more bluish color with the relative decrease in the illuminance of the ambient light.

Such variation in the color tone of the image light may be achieved in one embodiment as follows. For example, under circumstances where a resin material of such as a film in the display device 4 is not perfectly colorless nor is transparent and slightly has a yellowish color, the modulation layer 34 itself may be so configured as to have a lighter color or turn into colorless (become colorless and transparent) with the relative increase in the illuminance of the ambient light, and may be so configured as to have a bluish tone with the relative decrease in the illuminance of the ambient light (see FIG. 5).

It is preferable that the modulation layer 34 itself be so configured as to have a light color or turn into colorless (become colorless and transparent) with the relative increase in the illuminance of the ambient light, and be so configured as to have a bluish color with the relative decrease in the illuminance of the ambient light, also under circumstances where a resin material of such as a film in the display device 4 is not perfectly colorless nor is transparent and slightly has a bluish color. In this case, however, the bluish tone in the image light decreases with the relative increase in the illuminance of the ambient light, and the bluish tone in the image light increases with the relative decrease in the illuminance of the ambient light. Hence, in such case, the modulation layer 34 may so vary the color tone of the image light as to allow the image light to have a less bluish color with the relative increase in the illuminance of the ambient light, and to allow the image light to have a more bluish color with the relative decrease in the illuminance of the ambient light.

### [Function and Effect]

In the following, description is given on function and effects of the display device 4 according to the third embodiment.

In the present embodiment, the illumination light, having emitted from the illumination device 50 and having entered the polarizer 17, is converted by the polarizer 32 into the linearly-polarized light, following which the linearly-polarized light enters the liquid crystal layer 30. The light which has entered the liquid crystal layer 30 is modulated in the liquid crystal layer 30 in accordance with the image signal, following which the modulated light passes through the polarizer 36 to be emitted to the outside as the image light.

According to the present embodiment, the color tone of the image light varies depending on the illuminance of the ambient light. More specifically, when the ambient light is detected by the light detector 40 and the signal corresponding to the illuminance of that ambient light is thus outputted from the light detector 40, the voltage having a correlation with (for example, in proportional to or in inversely proportional to) the illuminance of the ambient light is applied by the driving circuit 60 to the transparent electrode layer 35 (or to the transparent electrode layer 22 and 35). This causes the modulation layer 34 to have the color tone corresponding to the illuminance of the ambient light.

For example, under circumstances where a resin material of such as a film in the display device 4 is not perfectly colorless nor is transparent and slightly has a yellowish color, the modulation layer 34 may have a lighter color or turn into colorless (become colorless and transparent) with the relative increase in the illuminance of the ambient light, and may have a more bluish color with the relative decrease in the illuminance of the ambient light. Also, the modulation layer 34 may have a lighter color or turn into colorless (become colorless and transparent) with the relative increase in the illuminance of the ambient light, and may have a more bluish color with the relative decrease in the illuminance of the ambient light, also under circumstances where a resin material of such as a film in the display device 4 is not perfectly colorless nor is transparent and slightly has a bluish color, for example.

This makes it possible to increase the luminance of the image light under the circumstances in which the illuminance of the ambient light is extremely large, as compared with a case where the illuminance of the ambient light is small. In other words, this makes it possible to increase the luminance of the image light of the image light more than that of the case where the illuminance of the ambient light is small under the circumstances in which the illuminance of the ambient light is extremely large, without varying the intensity of the light emitted from the illumination device 50. As a result, it is possible to improve visibility of a panel. It is to be noted that a user is, in general, interested in whether or not he or she can see and recognize an image rather than being interested in a color tone when the illuminance of the ambient light is extremely large, and thus the user hardly feels a sense of discomfort even when the image light is caused to have a yellowish tone as in the present embodiment. Hence, according to the fourth embodiment, it is possible to improve the visibility of the panel without bringing a sense of discomfort to the user.

### [Modification]

In one embodiment, the modulation layer 34 may be disposed at a location different from that according to the fourth embodiment described above. In this embodiment, it is preferable that a configuration is employed by which a voltage is applicable to the modulation layer 34.

### 5. Application Examples

Next, an application example of the display device according to any one of the embodiments and the modifications described above will be described below.

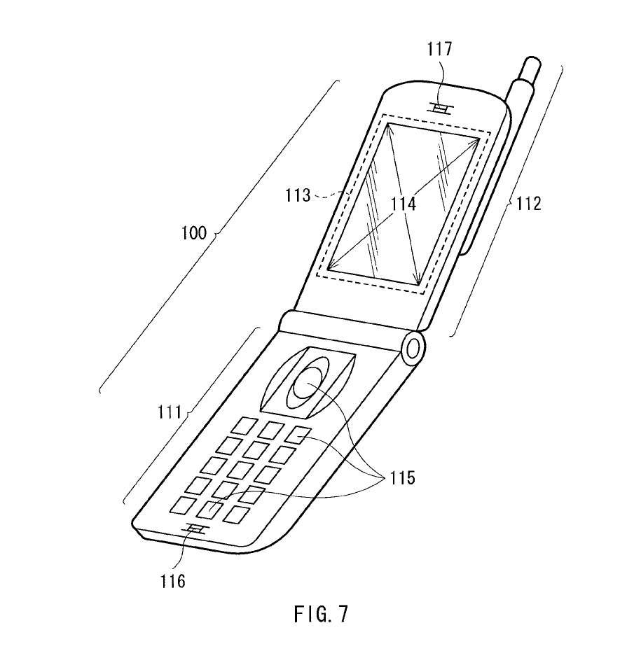

FIG. 7 is a perspective view illustrating an example of a schematic configuration of an electronic apparatus 100 according to one application example. The electronic apparatus 100 can be but not limited to a cellular phone. For example, the electronic apparatus 100 may include a main body 111, and a display section 112 provided to be openable and closable with respect to the main body 111, as illustrated in FIG. 17. The main body 111 includes operation buttons 115 and a transmitter section 116. The display section 112 includes a display device 113 and a receiver section 117. The display device 113 displays various indications related to a telephone communication on a display screen 114 thereof. The electronic apparatus 100 includes a control section (not illustrated) by which the operation of the display device 113 is controlled. The control section may be disposed in the main body 111 or in the display section 112, as a part of a controller that has control over the electronic apparatus 100 or as a control section provided separately from that controller.

The display device 113 has the same configuration as that of the display device according to any one of the embodiments and the modifications described above. Hence, it is possible for the display device 113 to display an image having improved visibility.

It is to be noted that the electronic apparatus to which the display device according to any one of the above-described embodiments and the modifications is applicable is not limited to the cellular phone described above. In addition to the cellular phone, the electronic apparatus can be, but not limited to: a personal computer; a television including a liquid crystal television; a video recorder including a viewfinder type videotape recorder and a monitor direct-view type videotape recorder; a car navigation system; a pager; an electronic organizer; an electronic calculator; a word processor; a work station; a videophone; a POS terminal, and other suitable electronic apparatus that employs a display.

Thus, it is possible to achieve at least the following configurations from the above-described example embodiments and the modifications of the disclosure.

(1) A display device, including:

a liquid crystal layer driven based on an image signal;

a reflection layer reflecting ambient light to the liquid crystal layer, the ambient light entering the reflection layer through the liquid crystal layer;

a retardation layer provided on a side of the liquid crystal layer from which the ambient light enters;

a polarizer provided on the side of the liquid crystal layer from which the ambient light enters; and

a modulation layer varying a color tone of image light depending on illuminance of the ambient light, the image light being reflected from the reflection layer and being emitted to outside through the liquid crystal layer, the retardation layer, and the polarizer.

(2) The display device according to (1), wherein the modulation layer varies the color tone of the image light to allow the image light to have a more bluish color with a relative increase in the illuminance of the ambient light, and to allow the image light to have a more yellowish color with a relative decrease in the illuminance of the ambient light.
(3) The display device according to (2), wherein the modulation layer has a more bluish color with the relative increase in the illuminance of the ambient light, and has a lighter color or turns into substantially colorless with the relative decrease in the illuminance of the ambient light.
(4) The display device according to (2) or (3), wherein the modulation layer includes a chromic material.
(5) The display device according to (4), wherein the modulation layer includes a photochromic material, and the polarizer allows ultraviolet rays to pass therethrough.
(6) The display device according to (5), wherein the modulation layer is an adhesion layer that is a single layer in a plane as a whole, or the modulation layer is a bonding layer that is a single layer in a plane as a whole.
(7) The display device according to (4), further including:

an electrode that applies a voltage to the modulation layer; and

a driving circuit that applies the voltage corresponding to the illuminance of the ambient light to the electrode,

wherein the modulation layer includes an electrochromic material.

(8) A display device, including:

a liquid crystal layer driven based on an image signal;

a first polarizer;

a second polarizer, the first polarizer and the second polarizer being disposed to face each other with the liquid crystal layer in between;

an illumination device allowing light to be emitted from the first polarizer to the second polarizer; and

a modulation layer varying a color tone of image light depending on illuminance of ambient light, the ambient light entering the modulation layer from a side of the modulation layer on which the second polarizer is provided, and the image light being emitted to outside through the first polarizer, the liquid crystal layer, and the second polarizer.

(9) The display device according to (8), wherein the modulation layer varies the color tone of the image light to allow the image light to have a more yellowish color with a relative increase in the illuminance of the ambient light, and to allow the image light to have a more bluish color with a relative decrease in the illuminance of the ambient light.
(10) The display device according to (9), wherein the modulation layer has a lighter color or turns into substantially colorless with the relative increase in the illuminance of the ambient light, and has a more bluish color with the relative decrease in the illuminance of the ambient light.
(11) The display device according to (9), wherein the modulation layer varies the color tone of the image light to allow the image light to have a less bluish color with the relative increase in the illuminance of the ambient light, and to allow the image light to have the more bluish color with the relative decrease in the illuminance of the ambient light.
(12) The display device according to (11), wherein the modulation layer has a lighter color or turns into substantially colorless with the relative increase in the illuminance of the ambient light, and has a more bluish color with the relative decrease in the illuminance of the ambient light.
(13) The display device according to any one of (9) to (12), wherein the modulation layer includes a chromic material.
(14) The display device according to (13), wherein the modulation layer includes a photochromic material, and each of the first polarizer and the second polarizer allows ultraviolet rays to pass therethrough.
(15) The display device according to (14), wherein the modulation layer is an adhesion layer that is a single layer in a plane as a whole, or the modulation layer is a bonding layer that is a single layer in a plane as a whole.
(16) The display device according to (13), further including:

an electrode that applies a voltage to the modulation layer; and

a driving circuit that applies the voltage corresponding to the illuminance of the ambient light to the electrode,

wherein the modulation layer includes an electrochromic material.

(17) An electronic apparatus with a display device, the display device including:

a liquid crystal layer driven based on an image signal;

a reflection layer reflecting ambient light to the liquid crystal layer, the ambient light entering the reflection layer through the liquid crystal layer;

a retardation layer provided on a side of the liquid crystal layer from which the ambient light enters;

a polarizer provided on the side of the liquid crystal layer from which the ambient light enters; and

a modulation layer varying a color tone of image light depending on illuminance of the ambient light, the image light being reflected from the reflection layer and being emitted to outside through the liquid crystal layer, the retardation layer, and the polarizer.

(18) An electronic apparatus with a display device, the display device including:

a liquid crystal layer driven based on an image signal;

a first polarizer;

a second polarizer, the first polarizer and the second polarizer being disposed to face each other with the liquid crystal layer in between;

an illumination device allowing light to be emitted from the first polarizer to the second polarizer; and

a modulation layer varying a color tone of image light depending on illuminance of ambient light, the ambient light entering the modulation layer from a side of the modulation layer on which the second polarizer is provided, and the image light being emitted to outside through the first polarizer, the liquid crystal layer, and the second polarizer.

As used herein, the terms such as “uniform”, “parallel”, “perpendicular”, “vertical” and “the same direction” include approximately uniform, approximately parallel, approximately perpendicular, approximately vertical, and approximately the same direction, respectively, insofar as effects achieved by the embodiments and the modifications are not impaired. Also, errors caused by various factors such as manufacturing errors and the variation may be included.

Also, as used herein, the term “plate” may be used interchangeably with the term “sheet”.

The present disclosure contains subject matter related to that disclosed in Japanese Priority Patent Application JP 2011-136567 filed in the Japan Patent Office on Jun. 20, 2011, the entire content of which is hereby incorporated by reference.

Although the technology has been described in terms of exemplary embodiments, it is not limited thereto. It should be appreciated that variations may be made in the described embodiments by persons skilled in the art without departing from the scope of the technology as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. Moreover, no element or component in this disclosure is intended to be dedicated to the public regardless of whether the element or component is explicitly recited in the following claims.

What is claimed is:

1. A display device, comprising:
a liquid crystal layer driven based on an image signal;
a reflection layer reflecting ambient light to the liquid crystal layer, the ambient light entering the reflection layer through the liquid crystal layer;
a retardation layer provided on a side of the liquid crystal layer from which the ambient light enters;
a polarizer provided on the side of the liquid crystal layer from which the ambient light enters; and
a modulation layer varying a color tone of image light depending on illuminance of the ambient light, the image light being reflected from the reflection layer and being emitted to outside through the liquid crystal layer, the retardation layer, and the polarizer.

2. The display device according to claim 1, wherein the modulation layer varies the color tone of the image light to allow the image light to have a more bluish color with a relative increase in the illuminance of the ambient light, and to allow the image light to have a more yellowish color with a relative decrease in the illuminance of the ambient light.

3. The display device according to claim 2, wherein the modulation layer has a more bluish color with the relative increase in the illuminance of the ambient light, and has a lighter color or turns into substantially colorless with the relative decrease in the illuminance of the ambient light.

4. The display device according to claim 2, wherein the modulation layer includes a chromic material.

5. The display device according to claim 4, wherein the modulation layer includes a photochromic material, and the polarizer allows ultraviolet rays to pass therethrough.

6. The display device according to claim 5, wherein the modulation layer is an adhesion layer that is a single layer in a plane as a whole, or the modulation layer is a bonding layer that is a single layer in a plane as a whole.

7. The display device according to claim 4, further comprising:
an electrode that applies a voltage to the modulation layer; and
a driving circuit that applies the voltage corresponding to the illuminance of the ambient light to the electrode,
wherein the modulation layer includes an electrochromic material.

8. A display device, comprising:
a liquid crystal layer driven based on an image signal;
a first polarizer;
a second polarizer, the first polarizer and the second polarizer being disposed to face each other with the liquid crystal layer in between;
an illumination device allowing light to be emitted from the first polarizer to the second polarizer; and
a modulation layer varying a color tone of image light depending on illuminance of ambient light, the ambient light entering the modulation layer from a side of the modulation layer on which the second polarizer is provided, and the image light being emitted to outside through the first polarizer, the liquid crystal layer, and the second polarizer.

9. The display device according to claim 8, wherein the modulation layer varies the color tone of the image light to allow the image light to have a more yellowish color with a relative increase in the illuminance of the ambient light, and to allow the image light to have a more bluish color with a relative decrease in the illuminance of the ambient light.

10. The display device according to claim 9, wherein the modulation layer has a lighter color or turns into substantially colorless with the relative increase in the illuminance of the ambient light, and has a more bluish color with the relative decrease in the illuminance of the ambient light.

11. The display device according to claim 9, wherein the modulation layer varies the color tone of the image light to allow the image light to have a less bluish color with the relative increase in the illuminance of the ambient light, and to allow the image light to have the more bluish color with the relative decrease in the illuminance of the ambient light.

12. The display device according to claim 11, wherein the modulation layer has a lighter color or turns into substantially colorless with the relative increase in the illuminance of the ambient light, and has a more bluish color with the relative decrease in the illuminance of the ambient light.

13. The display device according to claim 9, wherein the modulation layer includes a chromic material.

14. The display device according to claim 13, wherein the modulation layer includes a photochromic material, and each of the first polarizer and the second polarizer allows ultraviolet rays to pass therethrough.

15. The display device according to claim 14, wherein the modulation layer is an adhesion layer that is a single layer in a plane as a whole, or the modulation layer is a bonding layer that is a single layer in a plane as a whole.

16. The display device according to claim 13, further comprising:
an electrode that applies a voltage to the modulation layer; and
a driving circuit that applies the voltage corresponding to the illuminance of the ambient light to the electrode,
wherein the modulation layer includes an electrochromic material.

17. An electronic apparatus with a display device, the display device comprising:
a liquid crystal layer driven based on an image signal;
a reflection layer reflecting ambient light to the liquid crystal layer, the ambient light entering the reflection layer through the liquid crystal layer;
a retardation layer provided on a side of the liquid crystal layer from which the ambient light enters;
a polarizer provided on the side of the liquid crystal layer from which the ambient light enters; and
a modulation layer varying a color tone of image light depending on illuminance of the ambient light, the image light being reflected from the reflection layer and being emitted to outside through the liquid crystal layer, the retardation layer, and the polarizer.

18. An electronic apparatus with a display device, the display device comprising:
a liquid crystal layer driven based on an image signal;
a first polarizer;
a second polarizer, the first polarizer and the second polarizer being disposed to face each other with the liquid crystal layer in between;
an illumination device allowing light to be emitted from the first polarizer to the second polarizer; and
a modulation layer varying a color tone of image light depending on illuminance of ambient light, the ambient light entering the modulation layer from a side of the modulation layer on which the second polarizer is provided, and the image light being emitted to outside through the first polarizer, the liquid crystal layer, and the second polarizer.
